(19) United States
(12) Patent Application Publication
(10) Pub. No.: US 2008/0057968 A1
(43) Pub. Date: Mar. 6, 2008

(54) Wireless Communication Apparatus and Communication Control Method Thereof

(76) Inventors: Kenji Matsukuma, Fukuoka (JP); Michiharu Tanaka, Fukuoka (JP); Ryuichi Morita, Fukuoka (JP); Naoyuki Motomura, Fukuoka (JP); Hiroyuki Handa, Fukuoka (JP); Seiichiro Okada, Fukuoka (JP)

Correspondence Address: SUGHRUE-265550, 2100 PENNSYLVANIA AVE. NW, WASHINGTON, DC, 20037-3213, US

(21) Appl. No.: 10/581,662

(22) PCT Filed: Oct. 26, 2004
(86) PCT No.: PCT/JP04/15825

§ 371 Date: Mar. 23, 2007

(30) Foreign Application Priority Data
Dec. 3, 2003 (JP) 2003-404257

(51) Int. Cl. H04Q 7/20

(52) U.S. Cl. 455/450

(57) ABSTRACT

A wireless operating system is provided which can be applied even to such an environment that a plurality of controllers and a plurality of operating terminals are mixed with each other, and also, can readily establish communications within a short time.

A first wireless station transmits a calling instruction to a second wireless station via a connection-purpose channel which has been set, and when the first wireless station receives a response, the first wireless station switches the connection-purpose channel to a communication-purpose channel contained in the response data. Further, the second wireless station waits the calling instruction from the first wireless station via the preset connection-purpose channel, and when the second wireless station receives the calling instruction, the second wireless station seeks a channel which is not used so as to determine a communication channel, and transmits response data containing a communication-purpose channel number thereof to the first wireless station, and thereafter, switches the connection-purpose channel into the determined communication-purpose channel.

### TECHNICAL FIELD

The present invention relates to a wireless operation apparatus for operating industrial-purpose robots and numeral control apparatus such as machine tools in a wireless manner. More specifically, the present invention is directed to a control technique for wireless communication lines.

### RELATED ART

There are many cases that in machine tools and industrial-purpose robots, controllers for driving machines are located apart from actual working positions. When workers perform manual operations, the workers want to operate machines while the workers visually confirm places near actual working positions. However, on operating panels mounted on the above-explained controllers, the workers cannot easily operate the machines while confirming work conditions. As a consequence, such a method has been employed that while operating terminals are separately equipped with the controllers, the workers carry the operating terminals to places near the work positions and operate these operating terminals.

Furthermore, conventionally, operating terminals have been connected to controllers by using wire cables. However, very recently, connections by way of wireless communications having superior operability and superior portability are required.

As a first conventional technique for connecting an operating terminal to a controller, an operating terminal has been proposed which is featured by that while the operating terminal is connected to the controller by way of a wire manner only when a communication is first established, after the communication has been established, this wiring communication is cut out, and also, the wiring communication is switched to a wireless communication (refer to patent publication 1).

Further, as a second conventional technique, another system for establishing a wireless communication has been proposed in other industrial fields, for example, in such a technical field as to a mother unit and a child unit of a cordless telephone (refer to patent publication 2).

FIG. 9 is a block diagram for indicating a major portion of an arrangement of the second conventional technique. In FIG. 9, the cordless telephone is arranged by a first wireless station 1 corresponding to the child unit, and a second wireless station 2 corresponding to the mother unit.

In a multiscanning access system employed in wireless appliances, while a plurality of wireless channels are prepared in which usable wireless frequency bands are furthermore subdivided in narrower wireless frequency bands, since these wireless channels are separately set with respect to other wireless appliances, it is possible to avoid that communication speeds are lowered due to contention occurred among these wireless appliances. FIG. 9 schematically indicates this wireless channels.

The first wireless station 1 is provided with a transmitting/receiving unit 3, and a communication control unit 4, a button operating unit, a storage apparatus, and a battery (which are not shown). The first wireless station 1 is portable without being power-supplied from an external source. While the transmitting/receiving unit 3 can switch a plurality of wireless channels, the transmitting/receiving unit 3 modulates a voice signal and control data to obtain a wireless signal and transmits the wireless signal via the set wireless channel, or demodulates a voice signal and control data from a received signal via the set wireless channel. The communication control unit 4 controls the transmitting/receiving unit 3.

The second wireless station 2 is provided with a transmitting/receiving unit 5 and a communication control unit 6, and also equipped with a button operating unit and a storage apparatus (which are not shown). The second wireless station 2 has been connected to a telephone line (not shown). While the transmitting/receiving unit 5 can switch a plurality of wireless channels, the transmitting/receiving unit 5 modulates a voice signal and control data to obtain a wireless signal and transmits the wireless signal via the set wireless channel, or demodulates a voice signal and control data from a received signal via the set wireless channel. The communication control unit 6 controls the transmitting/receiving unit 5.

When a communication is established with employment of the above-described arrangement, a calling signal is transmitted from the mother unit to the child unit in the cordless telephone. In such a case that the child unit cannot grasp that this calling signal is transmitted via which wireless channel, the child unit is required to perform reception scanning operations over all of the wireless channels in order to catch this calling signal, and moreover, the child unit is required to perform access scanning operations for identifying as to whether or not a signal received via each of the wireless channels corresponds to the formal signal transmitted from the mother unit, which may impede the power saving effect of the child unit. In the second conventional technique, as one solving idea, such a method capable of reducing a total time of the access scanning operations by grouping the scanning channels.

Furthermore, in the patent publication 2, the communication control sequences between the mother unit and the child unit are described as the flow chart. The control sequences when the communication is established are extracted from the above-described communication control sequences, and then, the extracted control sequences are separated into a control sequence executed in the child unit and another control sequence executed in the mother unit, which will be explained with reference to drawings.

FIG. 10 is a flow chart for indicating a control sequence executed when a communication is established in the first wireless terminal 1 corresponding to the child unit. In FIG. 10, when a calling request is issued from an operator, the communication control unit 4 supplies a wireless channel number used in the preceding connecting operation which has been stored to the transmitting/receiving unit 3 in a step S301. In the next step S302, the transmitting/receiving unit 3 performs a receiving operation, and the communication control unit 4 checks an electric field strength in the wireless channel at this time. When the communication control unit 4 judges that the electric field strength is “high”, the communication control unit 4 recognizes that this wireless channel corresponds to a “not usable” channel, and then, the control operation is advanced to a step S304. When the communication control unit 4 judges that the electric field strength is “low”, the communication control unit 4 recognizes that this wireless channel corresponds to a “usable” channel, and then, the control operation is advanced to a step S304. In the step S303, in order to switch the present wireless channel to another wireless channel, the wireless channel number which is given to the transmitting/receiving unit 3 is updated, and the control sequence is returned to the step S302. In the step S304, the transmitting/receiving unit 3 transmits a calling instruction to the second wireless station 2, and then, the control sequence is advanced to a step S305. In the step S305, the transmitting/receiving unit 3 receives a response sent from the second wireless station 2. If the response is sent, then the control sequence is advanced to a step S306, whereas if the response is not sent, then the control sequence is advanced to a step S307. In the step S307, elapsed time after the user has issued the calling request is measured. If a predetermined time has already elapsed, then the communication control unit 4 judges that the time is over, and the control sequence is returned to the step S301 in which the communication control operations are retried from the beginning step. If the predetermined time has not yet elapsed, then the control sequence is returned to the step S305. In the step S306, the present wireless channel number is stored, so that the communication is established.

FIG. 11 is a flow chart for indicating control sequences executed when a communication is established in the second wireless station 2 corresponding to the mother unit. In FIG. 11, the communication control unit 6 checks as to whether or not a calling instruction is received from the first wireless station 1 in a step S401. If the communication control unit 6 does not receive the calling instruction in the wireless channel at this time, then the control sequence is advanced to a step S402, whereas if the communication control unit 6 receives the calling instruction in the wireless channel at this time, then the control sequence is advanced to a step S403. In the step S402, a wireless channel number given to the transmitting/receiving unit 5 is updated, and then, the control sequence is returned to the step S401. In the step S403, the channel number which has been given to the transmitting/receiving unit 5 at this time is stored in a storage apparatus (not shown), and then, the control sequence is advanced to a step S404. In the step S404, the communication control unit 6 transmits a response via this given wireless channel to the first wireless station 1, so that a communication is established.

As previously explained, in the second conventional technique, the child unit seeks the channel whose electric field strength is low so as to determine the communication channel, while the wireless channel through which the preceding communication could be established with respect to the mother unit is employed as the starting point. Since the mother unit sequentially access-scans the wireless channels within the set group, the mother unit catches the calling instruction issued from the child unit in order to establish the communication.

patent publication 1: JP-A-5-257515 (page 2, FIG. 1)
patent publication 2: JP-A-8-265823 (page 4, FIG. 1)

### DISCLOSURE OF THE INVENTION

### Problems that the Invention is to Solve

Accordingly, in the first conventional technique, every time the machine tool and the industrial-purpose robot are operated by the wireless control operation, or every time the power supplies of these machines are turned ON, the controllers are connected to the operating terminals by using the wire cables. As a result, the following problem occurs. That is, such a cumbersome operation is required that the user is moved to the predetermined positions so as to connect the controllers to the operating terminals, which may seriously bother the user.

Further, in accordance with the second conventional technique, in such a case that the conventional wireless communication establishing method designed for the cordless telephone is applied to the wireless operating system designed for the industrial-purpose robot and the numeral control apparatus, the mother unit corresponds to the controller, whereas the child unit corresponds to the operating terminal. In wireless operating systems, such environmental conditions that plural controllers and plural operating terminals are mixed with each other can be supposed, and thus, it is desirable in view of operability that users can connect any of these operating terminals to the respective controllers. However, the conventionally communication establishing method has been realized as the initial condition by being arranged with employment of one mother unit and one child unit, and therefore, owns the following problem. That is, the conventional communication establishing method cannot be applied to the case that a plurality of wireless stations are combined with each other so as to be used.

The present invention has been made to solve the above-described problems, and therefore, has an object to provide a wireless communication apparatus and a communication control method, which are capable of operating a machine tool and an industrial-purpose robot only by a wireless operating manner without requiring a wired connection between a controller and an operating terminal every time a wireless operation is carried out, or a power supply thereof is turned ON. Further, the wireless communication apparatus and the communication control method of the present invention can be applied even to such an environment that a plurality of controllers and a plurality of operating terminals are mixed with each other, and also, can readily establish communications within a short time.

### Means for Solving the Problems

To solve the above-explained problems, the present invention is arranged as follows:

According to the claim 1 of the present invention, there is provided a wireless communication apparatus for transmitting and receiving data between a first wireless station and a second wireless station in a wireless manner, wherein the first wireless station and a second wireless station comprise: transmitting/receiving units capable of switching a plurality of wireless channels; and communication control units which transmit and receive the data containing information as to a second wireless channel different from a first wireless channel via the first wireless channel with respect to the transmitting/receiving units, and switch the first wireless channel to the second wireless channel.

Further, according to claim 2 of the invention, there is provided the wireless communication apparatus as claimed in claim 1, wherein the data contains identification information specific to either the first wireless station or the second wireless station, which performs the transmission and the reception; and in the case that the identification information contained in the received data is made coincident with the identification information of the own wireless station, either the first wireless station or the second wireless station executes a wireless channel switching process operation based upon the data.

Further, according to claim 3 of the invention, there is provided the wireless communication apparatus as claimed in claim 1 or 2, wherein if the communication control unit can receive the data via a set wireless channel, the communication control unit judges that the set wireless channel is under use, and switches the set wireless channel to another communication channel; and the communication control unit seeks an unused wireless channel which is not used by another communication by repeating until the data is not received, and selects the unused wireless channel as the second wireless channel.

Further, according to claim 4 of the invention, there is provided the wireless communication apparatus as claimed in any one of claims 1 to 3, wherein the second wireless station corresponds to a controller for driving a machine; and the first wireless station corresponds to an operating terminal for operating the controller in a wireless manner.

Further, according to claim 5 of the invention, there is provided a communication control method of a wireless communication apparatus for transmitting and receiving data between a first wireless station and a second wireless station in a wireless manner, the method comprising the steps of: when a wireless communication is commenced, transmitting a calling signal which contains identification information of the second wireless station via a first wireless channel which has been previously and commonly set by the first wireless station, receiving a response signal from the second wireless station by the first wireless station, when the first wireless station confirms the own identification information contained in the response signal, the first wireless station switches the first wireless channel to the second wireless channel based upon the information of the second wireless channel contained in the response signal; receiving the calling signal from the first wireless station via the first wireless channel which has been previously and commonly set by the second wireless station, and when the second wireless station confirms the own identification information which is contained in the calling signal, seeking a second wireless channel which is different from the first wireless channel and is not used by the second wireless station, transmitting a response signal which contains the information of the second wireless channel and the identification information of the first wireless station via the first wireless channel by the second wireless station so as to switch the first wireless channel to the second wireless channel.

### ADVANTAGE OF THE INVENTION

In accordance with the present invention, since the appliances are connected to each other by employing the “public” wireless channel which is commonly used in the plurality of wireless stations, even under such an environment that the plural wireless stations are mixed with each other, the combinations of these wireless stations can be freely changed. Further, since the communication can be immediately established by the “public” connection-purpose wireless channel which is commonly used among the plural wireless stations, the communication establishment can be easily carried out within a short time, as compared with that for seeking the wireless channel by the conventional technique. Further, when the wireless communication is established, these wireless stations can be operated only by way of the wireless manner without requiring of connecting these wireless stations to each other by way of the wire cable. Furthermore, since the process operation for seeking the empty wireless channel is no longer required on the side of the child unit, the circuit arrangement thereof can be simplified and the power consumption thereof can be reduced, so that a long lifetime of a battery can be realized.

Further, in accordance with the invention recited in claim 2, since the exclusive processing operations using the mutual identification numbers can be carried out when the communication is established, even under such a condition that the plural wireless stations establish the wireless communications at the same time, the communication with the desirable wireless station can be firmly established without the erroneous connection.

Further, in accordance with the invention recited in claim 3, since the communication of the relevant wireless channel is directly measured, it is possible to more correctly judge as to whether or not the communication contention occurs.

Further, in accordance with the invention recited in claim 4, the wireless communication apparatus of the present invention can be applied to robots for driving machines by motors, and to operations of numeral control machine tools, while the controller and the operating terminal can perform the wireless transmitting/receiving operations without cumbersome operations.

### BRIEF DESCRIPTION OF THE DRAWINGS

FIG. 1 is a block diagram for indicating an arrangement of a first embodiment of the present invention.

FIG. 2 is a flow chart for indicating control sequences of a first wireless station according to the first embodiment of the present invention.

FIG. 3 is a flow chart for describing control sequences of a second wireless station according to the first embodiment of the present invention.

FIG. 4 is a flow chart for indicating control sequences of a first wireless station according to a second embodiment of the present invention.

FIG. 5 is a flow chart for describing control sequences of a second wireless station according to the second embodiment of the present invention.

FIG. 6 is a structural example of transmission/reception data in the second embodiment of the present invention.

FIG. 7 is a flow chart for describing control sequences of a second wireless station according to a third embodiment of the present invention.

FIG. 8 is a block diagram for representing an arrangement of a fourth embodiment of the present invention.

FIG. 9 is a block diagram for showing the arrangement of the second conventional technique.

FIG. 10 is a flow chart for indicating the control sequences of the first wireless station in the second conventional technique.

FIG. 11 is a flow chart for describing the control sequences of the second wireless station in the second conventional technique.

### DESCRIPTION OF REFERENCE NUMERALS AND SIGNS

1 first wireless station (child unit), 105 operating unit
2 second wireless station (mother unit), 106 battery
3 transmitting/receiving unit, 107 antenna
4 communication control unit, 200 controller
5 transmitting/receiving unit, 201 transmitting/receiving unit
6 communication control unit, 202 communication control unit
7 first wireless channel, 203 controller control unit
100 operating terminal, 204 storage apparatus
101 transmitting/receiving unit, 205 operating panel
102 communication control unit, 206 I/O device
103 operating terminal control unit, 207 antenna
104 storage apparatus, 300 drive shaft

### BEST MODE FOR CARRYING OUT THE INVENTION

Referring now to drawings, embodiments of the present invention of the present invention will be described.

It should be understood that although various functions and various means are built in an actual wireless station, only functions and means which are related to the present invention are described in drawings, and duplexed explanations thereof are omitted.

### Embodiment 1

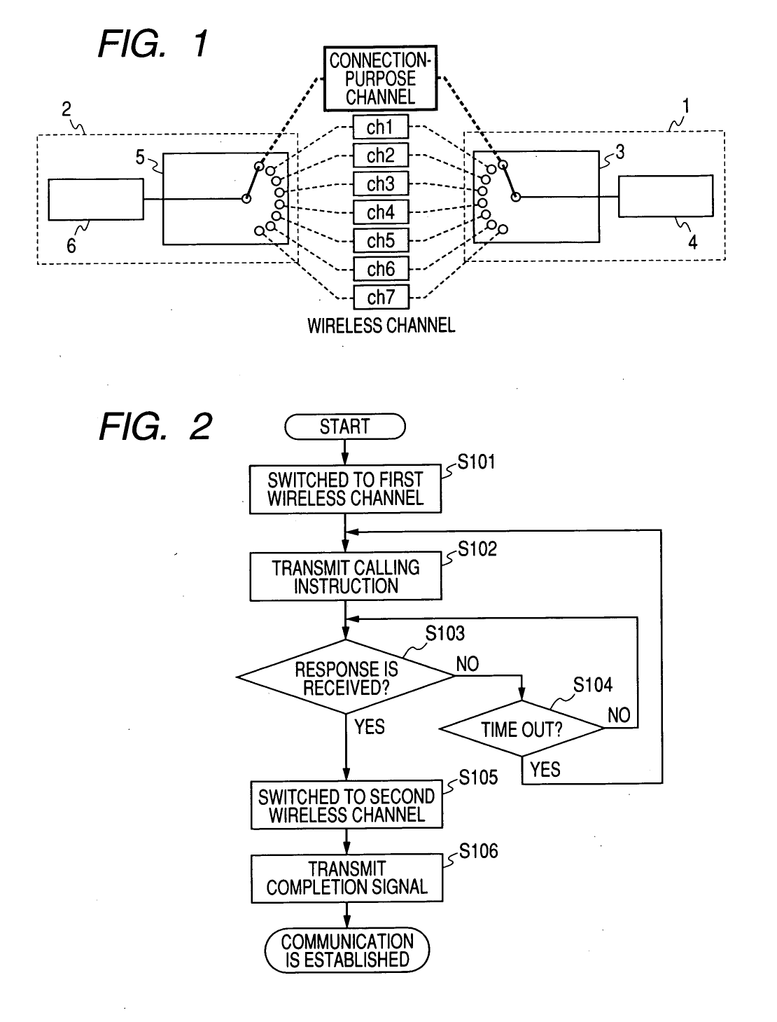

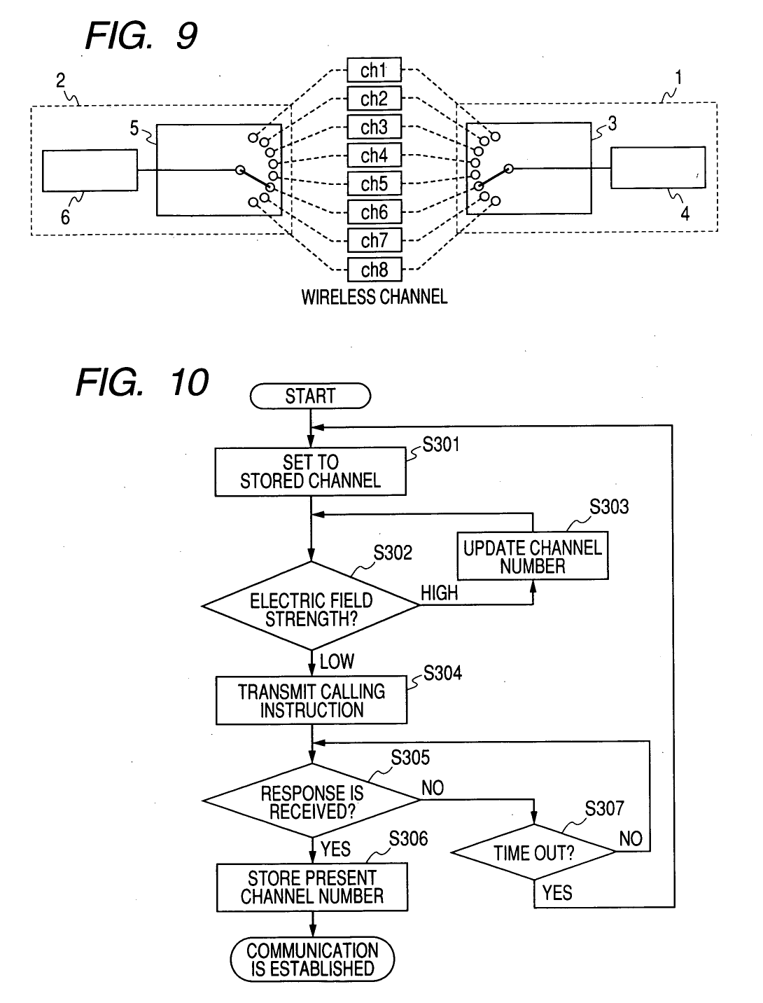

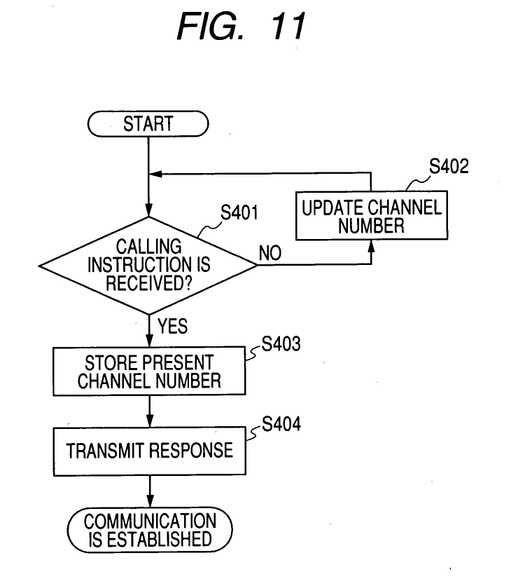

FIG. 1 is a block diagram for indicating an arrangement of a wireless operating system to which the present invention is applied. The wireless operating system has been constructed in a similar manner to that of FIG. 9 except for partial structures. It should also be noted that the same reference numerals indicate equivalent portions, and duplexed explanations thereof are omitted.

In a multiscanning access system employed in wireless appliances, while a plurality of wireless channels are prepared in which usable wireless frequency bands are furthermore subdivided in narrower wireless frequency bands, since these wireless channels are separately set with respect to other wireless appliances, it is possible to avoid that communication speeds are lowered due to contention occurred among these wireless appliances. FIG. 1 schematically indicates this wireless channel.

In this embodiment, a first wireless channel 7 among the plural wireless channels has been prepared as a “public” connection-purpose wireless channel which is commonly used in the respective wireless stations. The above-described first wireless channel 7 has been previously set when wireless stations are shipped, or has been arbitrarily set by operators to be stored in storage apparatus (not shown) of the respective wireless stations. The respective wireless stations have been arranged in such a manner that when communications are established, the respective wireless stations access the above-explained first wireless channel 7.

FIG. 2 is a flow chart for indicating control sequences of a first wireless station 1 executed when a communication is established among wireless stations.

In FIG. 2, when a calling request is issued from a user, a preset connection-purpose first wireless channel 7 is applied to the transmitting/receiving unit 3 so as to be switched to this first wireless channel 7 in a step S101.

In a step S102, the first wireless station 1 transmits a calling instruction to the second wireless station 2. This connection-purpose first wireless channel 7 corresponds to such a “public” wireless channel which is commonly used in a plurality of wireless stations, and is used only when a communication is established between wireless stations.

In a step S103, the first wireless station 1 judges as to whether or not response data from the second wireless station 2 is received. When the response data from the second wireless station 2 is received, the control sequence is advanced to a step S105. When the response data from the second wireless station 2 is not received, the control sequence is advanced to a step S104.

In the step S104, the first wireless station 1 judges as to whether or not a predetermined time has elapsed after the calling instruction has been transmitted in the step S102. If the predetermined time has already been elapsed, then the control sequence is returned to the step S102. If the predetermined time has not yet been elapsed, then the control sequence is returned to the step S103. Alternatively, instead of the control sequence returned to the step S102, the communication as a time out error, and the next operation may be carried out based upon a judgement of the user. The above-explained predetermined time may be set as data which has been previously set in a storage apparatus (not shown), or may be monitored by using a timer.

In a step S105, the transmitting/receiving unit 3 is switched to a second wireless channel based upon a new communication-purpose second wireless channel number which is contained in the response data in response to the calling instruction sent from the second wireless station 2.

In a step S106, since the first wireless station 1 transmits a completion signal via the second wireless channel to the second wireless station 2, the wireless communication establishment is completed.

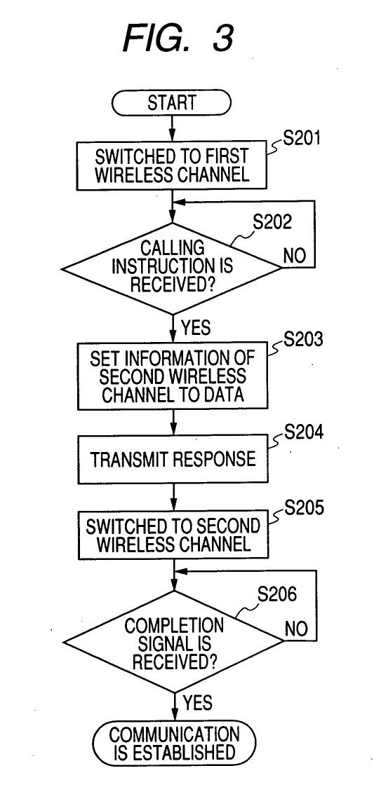

FIG. 3 is a flow chart for indicating control sequences of the second wireless station 2 when a communication is established between wireless stations.

In FIG. 3, is a step S201, the preset connection-purpose first wireless channel 7 is given to the transmitting/receiving unit 5 so as to switch the first wireless channel 7.

In a step S202, the second wireless station 2 waits to receive a calling instruction transmitted from the first wireless station 1. In this step S202, a called wireless station under such a condition that a wireless communication is not carried out between wireless stations is brought into calling instruction waiting condition. If the second wireless station 2 receives the calling instruction issued from the first wireless station 1, then the process operation is advanced to a step S203 in which information of a communication-purpose second wireless channel which is separately provided with respect to the first wireless channel 7 is set to response data.

In a step S204, the second wireless station 2 transmits the above-explained response data via the first wireless channel 7 to the first wireless station 1, and then, the control sequence is advanced to a step S205.

In the step S205, the wireless channel is switched to the second wireless channel.

In a step S206, since the second wireless station 2 receives a completion signal from the first wireless station 1 via the second wireless channel, the wireless communication establishment is completed.

As previously explained, in this embodiment, since the communication between the wireless stations is established by employing the commonly-used “public” wireless channel, even under such a condition that a plurality of wireless stations are mixed with each other, the combinations of these plural wireless stations can be freely changed. Further, the process operation for seeking the empty channel on the side of the first wireless station 1 is no longer required, so that the circuit arrangement of the first wireless station 1 can be made simpler and also the power consumption thereof can be reduced. Furthermore, the transmitting/receiving operations of the calling instruction can be immediately carried out via the connection-purpose first wireless channel 7, so that the communication can be established within a short time, as compared with the method for mutually switching the wireless channels so as to mutually seek the proper wireless channel, as explained in the conventional technique. After the calling instruction has been transmitted and received, the present wireless channel is advanced to another communication second wireless channel in a smooth manner, so that lowering of the communication speed due to the channel contention does not occur, but the communication can be effectively carried out.

In the above-explained arrangement, the calling request is transmitted from the first wireless satiation 1 to the second wireless satiation 2, and the response data containing the information of the second wireless channel is resent from the second wireless station 2 to the first wireless station 1. Alternatively, a calling response relationship opposite to the above-described calling response relationship may be employed. In other words, the calling request may be alternatively transmitted from the second wireless station 2 to the first wireless station 1, and the response data containing the information of the second wireless channel may be alternatively resent from the first wireless station 1 to the second wireless station 2. In this alternative case, the second wireless station 2 may be operated in accordance with the control sequences shown in FIG. 2, and the first wireless station 1 may be operated in accordance with the control sequences indicated in FIG. 3.

### Embodiment 2

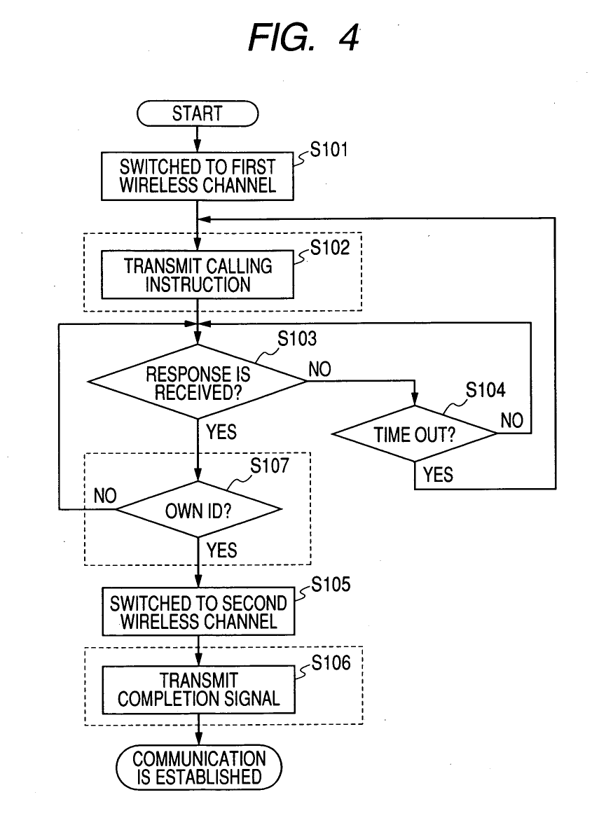

In the above-explained first embodiment, in the case that the plural wireless stations try to establish the wireless communications at the substantially same time, there is such a risk that the plural wireless stations cannot identify the counter wireless stations with each other, and thus are erroneously connected to each other. A measure capable of solving this risk will now be explained with reference to FIG. 4 through FIG. 6.

FIG. 4 is a flow chart for describing control sequences of the first wireless station 1 when a communication is established between the wireless stations in a second embodiment to which the present invention is applied. Comparing with the flow chart of FIG. 2, portions which are surrounded by broken lines are changed, or are newly added. It should be understood that in step numbers denoted by the same numerals, the same process operations are executed, and explanations thereof are omitted.

In this embodiment, in a step S102, the first wireless station 1 transmits such a data which contains an identification number of the second wireless station 2 and contains an identification number of the own first wireless station 1 as a calling instruction, while the second wireless station 2 constitutes a communication subject.

Further, in a step S107, the first wireless station 1 checks as to whether or not the identification number of the communication subject, which is contained in the data of the response signal received from the second wireless station 2, is coincident with the own identification number. If the identification number of the communication subject is coincident with the own identification number, then the control sequence is advanced to a step S105. If the identification number of the communication subject is not coincident with the own identification number, then the control sequence is returned to the step S103.

Similar to the step S102, even in a step S106, the data which contains the identification number of the second wireless station 2 which constitutes the communication subject, and also contains the own identification number of the first wireless station 1 is transmitted as a completion signal.

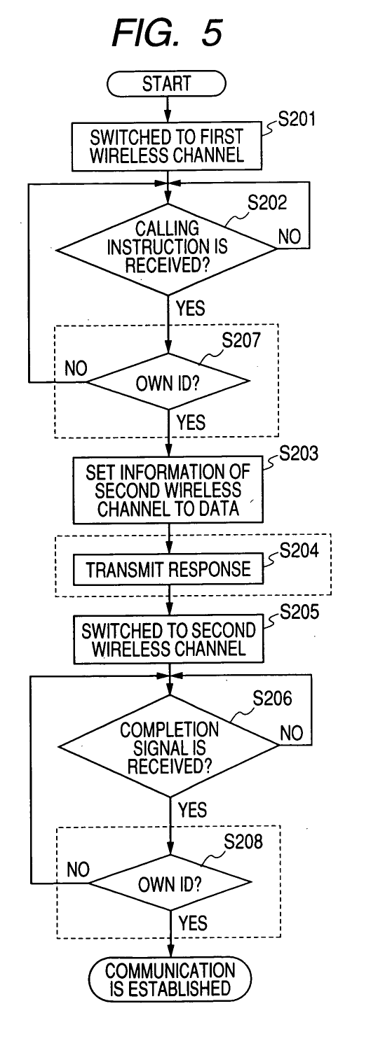

FIG. 5 is flow chart for describing control sequences of the second wireless station 2 when a communication is established between wireless stations in the second embodiment to which the present invention is applied. Comparing with the flow chart of FIG. 3, portions which are surrounded by broken lines are changed, or are newly added. It should be understood that in step numbers denoted by the same numerals, the same process operations are executed, and explanations thereof are omitted.

In a step S207, the second wireless station 2 checks as to whether or not an identification number of a communication subject, which is contained in data of a response signal received from the first wireless station 1, is coincident with the own identification number. If the identification number of the communication subject is coincident with the own identification number, then the control sequence is advanced to a step S203. If the identification number of the communication subject is not coincident with the own identification number, then the control sequence is returned to the step S202.

Further, in a step S204, the data which contains the identification number of the first wireless station 1 which constitutes the communication subject, and also contains the own identification number of the second wireless station 2 is transmitted as a response signal.

Similar to the step S207, even in a step S208, the second wireless station 2 checks as to whether or not an identification number of a communication subject, which is contained in data of a response signal received from the first wireless station 1, is coincident with the own identification number. If the identification number of the communication subject is coincident with the own identification number, then the second wireless station 2 judges that the establishment of the communication is completed. If the identification of the communication subject is not coincident with the own identifier number, then the control sequence is returned to the step S206.

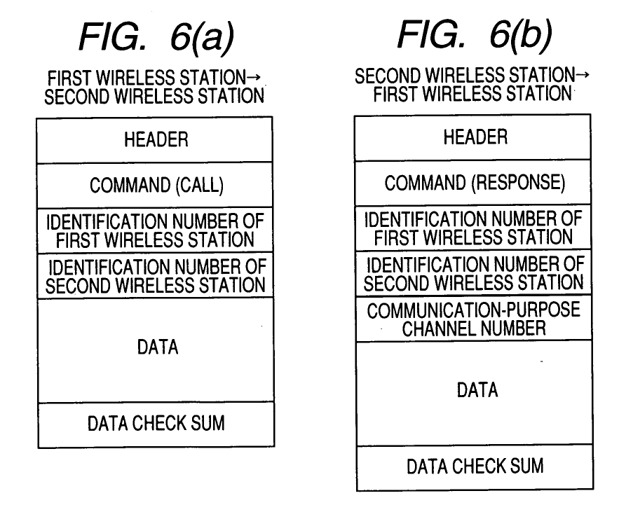

FIG. 6 shows a structural example as to data which is transmitted/received between the first wireless station 1 and the second wireless station 2. In FIG. 6, (a) indicates a data structure as to a calling instruction and a completion signal, which are transmitted from the first wireless station 1 to the second wireless station 2. This data structure contains the identification number of the second wireless station which constitutes the connection subject, and the identification number of the first wireless station 1 itself. (b) represents a data structure of a response signal which is transmitted from the second wireless station 2 to the first wireless station 1. This data structure contains the identification number of the first wireless station 1 which receives the identification number and the calling instruction of the second wireless station 2 itself, and the communication-purpose second wireless channel number which is judged as the “usable” channel number. Alternatively, check data such as CRCC may be added to any of these data in order to improve reliability of communications.

In accordance with this embodiment, since the exclusive processing operations using the mutual identification numbers can be carried out when the communication is established, even under such a condition that the plural wireless stations establish the wireless communications at the same time, the communication with the desirable wireless station can be firmly established without the erroneous connection.

### Embodiment 3

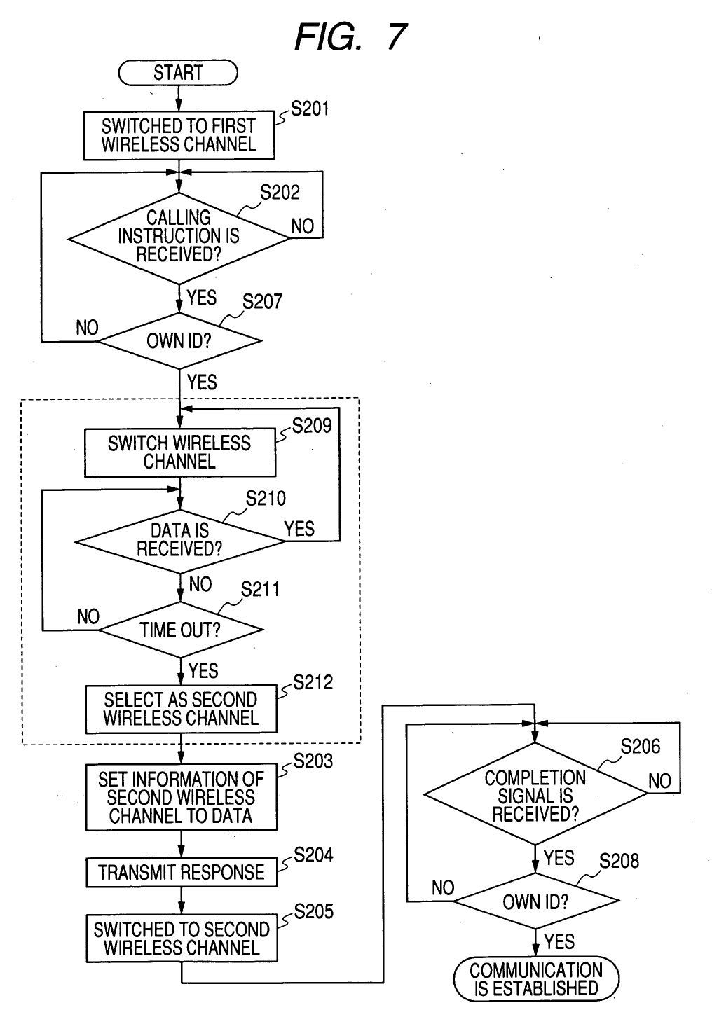

A description is made of a method for determining a communication-purpose second wireless channel with reference to FIG. 7.

FIG. 7 is a flow chart for describing control sequences of the second wireless station 2 when a communication is established between wireless stations in a third embodiment to which the present invention is applied. Comparing with the flow chart of FIG. 5, portions which are surrounded by broken lines are changed, or are newly added. It should be understood that in step numbers denoted by the same numerals, the same process operations are executed, and explanations thereof are omitted.

In this embodiment, the second wireless station 2 switches the above-explained first wireless channel 7 to another wireless channel in a step S209, and receives a communication of this switched wireless channel in order to check as to whether or not data transmitted from another wireless station is not received in step S210. If the data is received, then the second wireless station 2 judges that the wireless channel is under use, and then, the control sequence is returned to the step S209 in which the second wireless station 2 switches the present wireless channel to a further wireless channel. When data is not received, the control sequence is advanced to a step S211. In this step S111, the second wireless station 2 judges as to whether or not a predetermined time has already been elapsed since the wireless channel is switched at the step S209. In the case that the predetermined time has not yet been elapsed, the control sequence is returned to the step S210 in which the second wireless station 2 continuously receives data. When the predetermined time has already been elapsed, the second wireless station 2 judges that the wireless channel is under no use, and then, the control sequence is advanced to a step S212 in which the wireless channel is selected as the communication-purpose second wireless channel.

In the example shown in the second conventional technique, in the step S302, the transmitting/receiving unit 3 performs the receiving operation, and the judgement is made as to whether or not the channel is used based upon the signal strength of the reception signal of the channel, which is received at this time. In contrast thereto, in this embodiment, in the step S210, in such a case that the subject wireless channel is received for the preset time and the data is received from another wireless station, the second wireless station 2 judges that the subject wireless channel is under use, whereas in the case that the data transmitted from another wireless station is not received, the second wireless station 2 judges that the subject wireless channel corresponds to the empty wireless channel.

In accordance with this embodiment, in comparison with the second conventional technique in which the present wireless channel is regarded as the empty channel by such a fact that the signal strength is low, since the communication of the relevant wireless channel is directly received, it is possible to more correctly judge as to whether or not the communication contention occurs.

### Embodiment 4

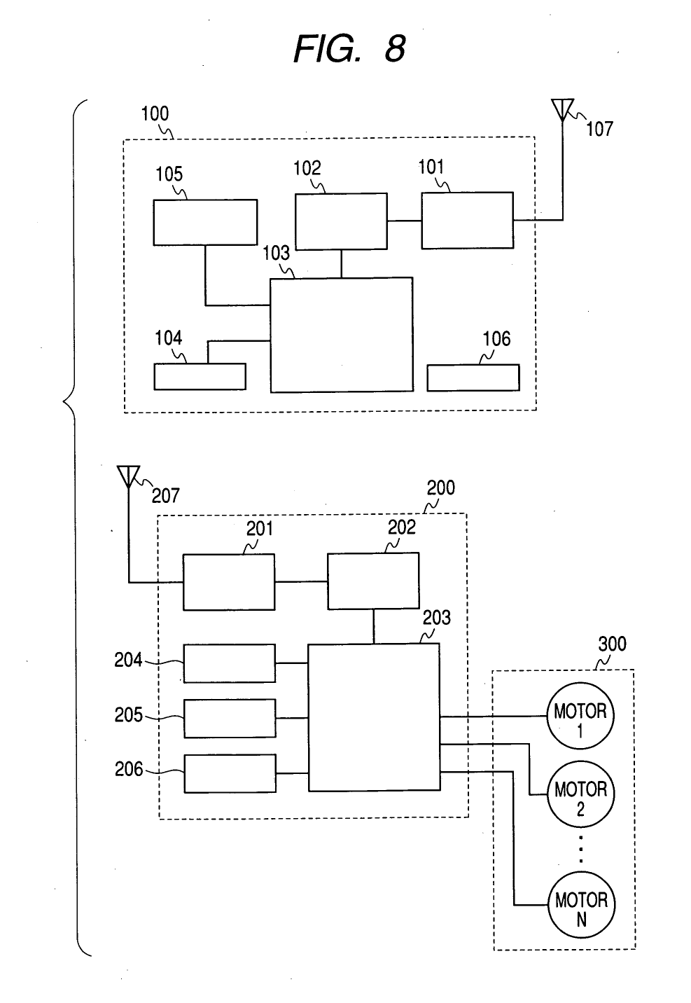

A description is made of a fourth embodiment based upon FIG. 8, in which the present invention is applied to a controller for driving a machine and an operating terminal thereof.

In FIG. 8, reference numeral 100 indicates the operating terminal which corresponds to the first embodiment 1 of the previously explained embodiment. Reference numeral 101 indicates a transmitting/receiving unit; reference numeral 102 shows a communication control unit; reference numeral 103 indicates an operating terminal control unit; reference numeral 104 denotes a storage apparatus; reference numeral 105 shows an operating unit; reference numeral 106 indicates a battery; and reference numeral 107 shows an antenna. Reference numeral 200 indicates a controller which corresponds to the second wireless station 2 of the previously explained embodiment. Reference numeral 201 shows a transmitting/receiving unit; reference numeral 202 represents a communication control unit; reference numeral 203 indicates a controller control unit; reference numeral 204 represents a storage apparatus; reference numeral 205 shows an operating panel; reference numeral 206 denotes an I/O device; and reference numeral 207 represents an antenna. Further, reference numeral 300 shows a drive shaft. In this arrangement, for instance, in an industrial-purpose robot, the drive shaft 300 corresponds to a robot main body; the controller 200 corresponds to a robot control apparatus for controlling operations of the robot main body; and the operating terminal 100 corresponds to a teaching pendant for teaching a work program executed by the robot.

The operating terminal control unit 103 has been connected to the communication control unit 102, the storage apparatus 104, and the operating unit 105, and controls the entire unit of the operating terminal 100. Further, the communication control unit 102 controls the transmitting/receiving unit 101. While the operating unit 105 is equipped with a human interface such as switches and display devices, this operating unit 105 is used when a person manually operates the operating unit 105. The operating unit 105 converts the information which is manually operated by the person into a signal and outputs the signal to the operating terminal control unit 103, and inputs thereinto display-purpose data derived from the operating terminal control unit 103 so as to convert the display-purpose data into a display-purpose signal, and then, displays the data.

The operating terminal control unit 103 enters thereinto a signal supplied from the operating unit 105 so as to analyze the entered signal, and stores the analyzed data as operation data into the storage apparatus 104, and also, reads out display-purpose data from the storage apparatus 104 to output the read display-purpose data to the operating unit 105. Further, the operating terminal control unit 103 reads out the operation data stored in the storage apparatus 104, and transmits a command to the communication control unit 102 based upon the read operation data. The communication control unit 102 inputs reception data from the transmitting/receiving unit 101 and outputs the reception data to the operating terminal control unit 103.

The transmitting/receiving unit 101 inputs transmission data from the communication control unit 102 in accordance with the control operation by the communication control unit 102 so as to convert the transmission data into a transmission signal, and then, outputs the transmission signal to the antenna 107. The transmitting/receiving unit 101 inputs a reception signal from the antenna 107 so as to convert the reception signal into reception data, and then, outputs the reception data to the communication control unit 102.

Reference numeral 106 indicates a battery for supplying electric power to the operating terminal 100.

While the controller control unit 203 has been connected to the communication control unit 202, the storage apparatus 204, the operating panel 205, the I/O device 206, and the drive shaft 300, the controller control unit 203 controls the entire portion of the controller 200. Further, the communication control unit 202 controls the transmitting/receiving unit 201.

While the operating panel 205 is equipped with a human interface such as switches and display devices, this operating panel 205 is used when a person mainly and manually operates the controller 200. The operating panel 205 converts the information which is manually operated by the person into a signal and outputs the signal to the controller control unit 203, and inputs thereinto display-purpose data derived from the controller control unit 203 so as to convert the display-purpose data into a display-purpose signal, and then, displays the data. Further, the I/O device 206 corresponds to such a device which inputs thereinto signals supplied from a machine unit controlled by the controller 200, and a limit switch etc., which detects an operating position of a jig to output the inputted signals to the controller control unit 203; enters thereinto a signal for controlling a solenoid, or the like from the controller control unit 203 to output the control signal to the machine unit and the jig. Further, the I/O device 206 corresponds to such a device which inputs/outputs program data and teach data, which are used to determine operations of the above-described machine into/from the controller control unit 203. Further, the drive shaft 300 is controlled by the controller control unit 203, and corresponds to a motor which drives the machine. Although a total number of the shafts is determined as N shafts in this embodiment, this total number is determined based upon a freedom degree of the above-explained mechanism.

While the communication control unit 202 has been connected to the transmitting/receiving unit 201 and the controller control unit 203, the communication control unit 202 transmits and receives both a command and data with respect to the controller control unit 203 so as to control the transmitting/receiving unit 201. The transmitting/receiving unit 201 inputs transmission data from the communication control unit 202 in accordance with the control operation by the communication control unit 202 so as to convert the transmission data into a transmission signal, and then, outputs the transmission signal to the antenna 207; and enters a reception signal from the antenna 207 so as to convert the reception signal into reception data which is outputted to the communication control unit 102.

In accordance with this embodiment, the inventive idea can also be applied to such an environment that the plural controllers and the plural operating terminals are mixed with each other, and the communication can be easily established within a short time.

The fourth embodiment has described such a case that the operating terminal 100 corresponds to the first wireless station 1, the controller 200 corresponds to the second wireless station 2, and the user inputs the calling request from the operating terminal 100. Alternatively, such a reversed arrangement may be realized in which the controller 200 corresponds to the first wireless station 1, the operating terminal 100 corresponds to the second wireless station 2, and the user inputs the calling request from the controller.

### INDUSTRIAL APPLICABILITY

The present invention can be utilized as a positioning apparatus of a semiconductor device manufacturing apparatus, and a control apparatus for operating a machine tool and an industrial-purpose robot in a wireless manner.

1. A wireless communication apparatus for transmitting and receiving data between a first wireless station and a second wireless station in a wireless manner, wherein
the first wireless station and a second wireless station comprise:
transmitting/receiving units capable of switching a plurality of wireless channels; and
communication control units which transmit and receive the data containing information as to a second wireless channel different from a first wireless channel via the first wireless channel with respect to the transmitting/receiving units, and switch the first wireless channel to the second wireless channel.

2. The wireless communication apparatus as claimed in claim 1 wherein
the data contains identification information specific to either the first wireless station or the second wireless station, which performs the transmission and the reception; and
in the case that the identification information contained in the received data is made coincident with the identification information of the own wireless station, either the first wireless station or the second wireless station executes a wireless channel switching process operation based upon the data.

3. The wireless communication apparatus as claimed in claim 1 or 2, wherein
if the communication control unit can receive the data via a set wireless channel, the communication control unit judges that the set wireless channel is under use, and switches the set wireless channel to another communication channel; and
the communication control unit seeks an unused wireless channel which is not used by another communication by repeating until the data is not received, and selects the unused wireless channel as the second wireless channel.

4. The wireless communication apparatus as claimed in any one of claims 1 to 3, wherein
the second wireless station corresponds to a controller for driving a machine; and
the first wireless station corresponds to an operating terminal for operating the controller in a wireless manner.

5. A communication control method of a wireless communication apparatus for transmitting and receiving data between a first wireless station and a second wireless station in a wireless manner,
the method comprising the steps of:
when a wireless communication is commenced,
transmitting a calling signal which contains identification information of the second wireless station via a first wireless channel which has been previously and commonly set by the first wireless station,
receiving a response signal from the second wireless station by the first wireless station,
when the first wireless station confirms the own identification information contained in the response signal, the first wireless station switches the first wireless channel to the second wireless channel based upon the information of the second wireless channel contained in the response signal,
receiving the calling signal from the first wireless station via the first wireless channel which has been previously and commonly set by the second wireless station, and
when the second wireless station confirms the own identification information which is contained in the calling signal, seeking a second wireless channel which is different from the first wireless channel and is not used by the second wireless station,
transmitting a response signal which contains the information of the second wireless channel and the identification information of the first wireless station via the first wireless channel by the second wireless station so as to switch the first wireless channel to the second wireless channel.
